(19) United States
(12) Patent Application Publication
(10) Pub. No.: US 2018/0191122 A1
(43) Pub. Date: Jul. 5, 2018

(54) LASER GAS PURIFYING SYSTEM

(71) Applicant: Gigaphoton Inc., Tochigi (JP)

(72) Inventors: Natsushi SUZUKI, Oyama-shi (JP); Masanori YASHIRO, Oyama-shi (JP); Osamu WAKABAYASHI, Oyama-shi (JP)

(73) Assignee: Gigaphoton Inc., Tochigi (JP)

(21) Appl. No.: 15/910,689

(22) Filed: Mar. 2, 2018

Related U.S. Application Data
(63) Continuation of application No. PCT/JP2015/080278, filed on Oct. 27, 2015.

(51) Int. Cl. H01S 3/036; H01S 3/225; H01S 3/104

(52) U.S. Cl. CPC H01S 3/036; H01S 3/225; H01S 3/2207; B01D 2253/108; H01S 3/104

(57) ABSTRACT

A laser gas purifying system is configured to purify emission gas emitted from an ArF excimer laser apparatus using laser gas including xenon gas and to supply the purified gas to the ArF excimer laser apparatus. The laser gas purifying system comprises a xenon trap configured to reduce xenon gas concentration in the emission gas, and a xenon-adding unit configured to add xenon gas to the emission gas passed through the xenon trap.

### TECHNICAL FIELD

The present disclosure relates to a laser gas purifying system.

### BACKGROUND ART

The recent miniaturization and the increased levels of integration of semiconductor integrated circuits have led to a demand for increasing in a resolution of semiconductor exposure apparatuses. A semiconductor exposure apparatus is hereinafter referred to simply as “exposure apparatus”. Accordingly, exposure light sources to emit light at shorter wavelengths have been under development. As the exposure light sources, gas laser apparatuses instead of conventional mercury lamps are typically used. The gas laser apparatuses for exposure include a KrF excimer laser apparatus that emits an ultraviolet laser beam at a wavelength of 248 nm and an ArF excimer laser apparatus that emits an ultraviolet laser beam at a wavelength of 193 nm.

As an advanced exposure technology, immersion exposure has been put into practical use. In the immersion exposure, a gap between an exposure lens and a wafer in an exposure apparatus is filled with a fluid such as water. The immersion exposure allows the refractive index of the gap to be changed and thus an apparent wavelength of the light from the exposure light source is shortened. The immersion exposure using an ArF excimer laser apparatus as an exposure light source allows a wafer to be irradiated with ultraviolet light having a wavelength in water of 134 nm. This technology is referred to as “ArF immersion exposure” or “ArF immersion lithography”.

Spectral line widths of KrF and ArF excimer laser apparatuses in natural oscillation are as wide as approximately 350 pm to 400 pm. This may cause chromatic aberration by using exposure lenses that are made of a material that transmits ultraviolet light such as KrF and ArF laser beams. The chromatic aberration thus causes a reduction in resolution. Accordingly, the spectral line width of the laser beam outputted from the gas laser apparatus needs to be narrowed to such an extent that the chromatic aberration can be ignored. To narrow the spectral line width, a laser resonator of a gas laser apparatus may be equipped with a line narrow module (LNM) having a line narrow element. The line narrow element may be an etalon, a grating, or the like. A laser apparatus whose spectral line width is narrowed is hereinafter referred to as “line narrowed laser apparatus”.
Patent Document 1: International Publication No. WO 2015/075840 A
Patent Document 2: U.S. Pat. No. 6,714,577 B
Patent Document 3: U.S. Pat. No. 6,188,710 B
Patent Document 4: U.S. Pat. No. 6,922,428 B
Patent Document 5: U.S. Pat. No. 6,819,699 B
Patent Document 6: U.S. Pat. No. 6,496,527 B
Patent Document 7: Japanese Patent No. 5216220 B
Patent Document 8: US Patent Application Publication No. 2010/0086459 A
Patent Document 9: Japanese Patent No. 3824838 B

### SUMMARY

An aspect of the present disclosure may be related to a laser gas purifying system configured to purify emission gas emitted from an ArF excimer laser apparatus using laser gas including xenon gas and to supply the purified gas to the ArF excimer laser apparatus. The laser gas purifying system comprises a xenon trap configured to reduce xenon gas concentration in the emission gas, and a xenon-adding unit configured to add xenon gas to the emission gas passed through the xenon trap.

### BRIEF DESCRIPTION OF DRAWINGS

Embodiments of the present disclosure will be described below as mere examples with reference to the attached drawings.

FIG. 1 schematically shows a configuration of an excimer laser apparatus 30 and a laser gas purifying system 50 according to a comparative example.

FIG. 2 is a flowchart showing a process of a gas controller 47 of the excimer laser apparatus 30 according to the comparative example.

FIG. 3 is a flowchart showing details of a process of S190 shown in FIG. 2.

FIG. 4 schematically shows a configuration of an excimer laser apparatus 30 and a laser gas purifying system 50a according to a first embodiment of the present disclosure.

FIG. 5 is a flowchart showing a process of a gas purification controller 51 of the laser gas purifying system 50a according to the first embodiment.

FIG. 6 is a flowchart showing details of a process of S410 shown in FIG. 5.

FIG. 7 schematically shows a configuration of excimer laser apparatuses 30a and 30b and a laser gas purifying system 50b according to a second embodiment of the present disclosure.

FIG. 8 is a flowchart showing a process of a gas purification controller of a laser gas purifying system according to a third embodiment of the present disclosure.

FIG. 9 is a cross-sectional view of a first exemplary configuration of a xenon trap used in the embodiments described above.

FIG. 10 is a cross-sectional view of a second exemplary configuration of the xenon trap used in the embodiments described above.

FIG. 11 schematically shows a second exemplary configuration of a xenon-adding unit used in the embodiments described above.

FIG. 12 schematically shows an exemplary configuration of a mixer 70 used in the embodiments described above.

FIG. 13 is a block diagram of a general configuration of a controller.

### DESCRIPTION OF EMBODIMENTS

### Contents

### 1. Summary

### 2. Excimer Laser Apparatus and Laser Gas Purifying System According to Comparative Example

2.1 Configuration
2.1.1 Excimer Laser Apparatus
   2.1.1.1 Laser Oscillation System
   2.1.1.2 Laser Gas Control System
2.1.2 Laser Gas Purifying System

2.2 Operation
2.2.1 Operation of Excimer Laser Apparatus
   2.2.1.1 Operation of Laser Oscillation System
   2.2.1.2 Operation of Laser Gas Control System
2.2.2 Operation of Laser Gas Purifying System

2.3 Problem

### 3. Laser Gas Purifying System Including Xenon Trap

3.1 Configuration

3.2 Operation

3.3 Process of Gas Purification Controller

3.4 Supplementary Explanation

3.5 Effect

### 4. Laser Gas Purifying System Connected to Plurality of Laser Apparatuses

4.1 Configuration

4.2 Operation

4.3 Effect

### 5. Laser Gas Purifying System That Determines End of Lifetime of Xenon Trap

### 6. Specific Configuration of Xenon Trap

6.1 First Exemplary Configuration

6.2 Operation of First Exemplary Configuration

6.3 Second Exemplary Configuration

### 7. Specific Configuration of Xenon-Adding Unit

### 8. Specific Configuration of Mixer

### 9. Configuration of Controller

Embodiments of the present disclosure will be described in detail below with reference to the drawings. The embodiments described below show examples of the present disclosure and do not intend to limit the content of the present disclosure. Not all of the configurations and operations described in each embodiment are indispensable in the present disclosure. Identical reference symbols may be assigned to identical constituent elements and redundant descriptions thereof may be omitted.

### 1. Summary

An embodiment of the present disclosure may relate to a laser gas purifying system. The laser gas purifying system may be used with a laser apparatus. The laser apparatus may be a discharge-excited gas laser apparatus. The discharge-excited gas laser apparatus may be configured such that a predetermined voltage is applied to a pair of electrodes provided in a chamber to cause an electric discharge to excite laser gas in the chamber.

The discharge-excited gas laser apparatus in the embodiment of the present disclosure may be an ArF excimer laser apparatus. The laser gas used in the ArF excimer laser apparatus may include argon gas, neon gas, and fluorine gas. The laser gas may also include, to stabilize the electric discharge, a small amount of xenon gas. The amount of xenon gas in the laser gas may be, for example, around 10 ppm.

Laser oscillation of the ArF excimer laser apparatus for a long time may cause impurities to be generated in the laser gas in the chamber of the laser apparatus. The impurities generated in the laser gas may absorb a part of the pulse laser beam or worsen a condition of the electric discharge. The impurities generated in the laser gas may thus make it difficult or impossible to output the pulse laser beam having desired energy.

A proposal has been made, for outputting a pulse laser beam having desired energy, to reduce impurities in emission gas emitted from the chamber and to return purified gas with a reduced amount of impurities to the chamber. The purified gas returned to the chamber may mainly include an inert gas such as argon gas, neon gas, and xenon gas. A part of the xenon gas in the chamber may react with fluorine gas in the chamber to form xenon fluoride. Thus, xenon gas concentration in the chamber may be slightly reduced. Repeating re-use of the purified gas without supplying xenon gas may further reduce the xenon gas concentration. Here, an optimum range of the xenon gas concentration in an ArF excimer laser apparatus may be so narrow that small change in the xenon gas concentration may affect the laser performance.

The laser gas purifying system according to the embodiment of the present disclosure may be configured to purify the emission gas emitted from the ArF excimer laser apparatus using the laser gas including xenon gas and to supply the purified gas to the ArF excimer laser apparatus. The laser gas purifying system may include a xenon trap configured to reduce the xenon gas concentration in the emission gas and a xenon-adding unit configured to add xenon gas to the emission gas having passed through the xenon trap.

### 2. Excimer Laser Apparatus and Laser Gas Purifying System According to Comparative Example

### 2.1 Configuration

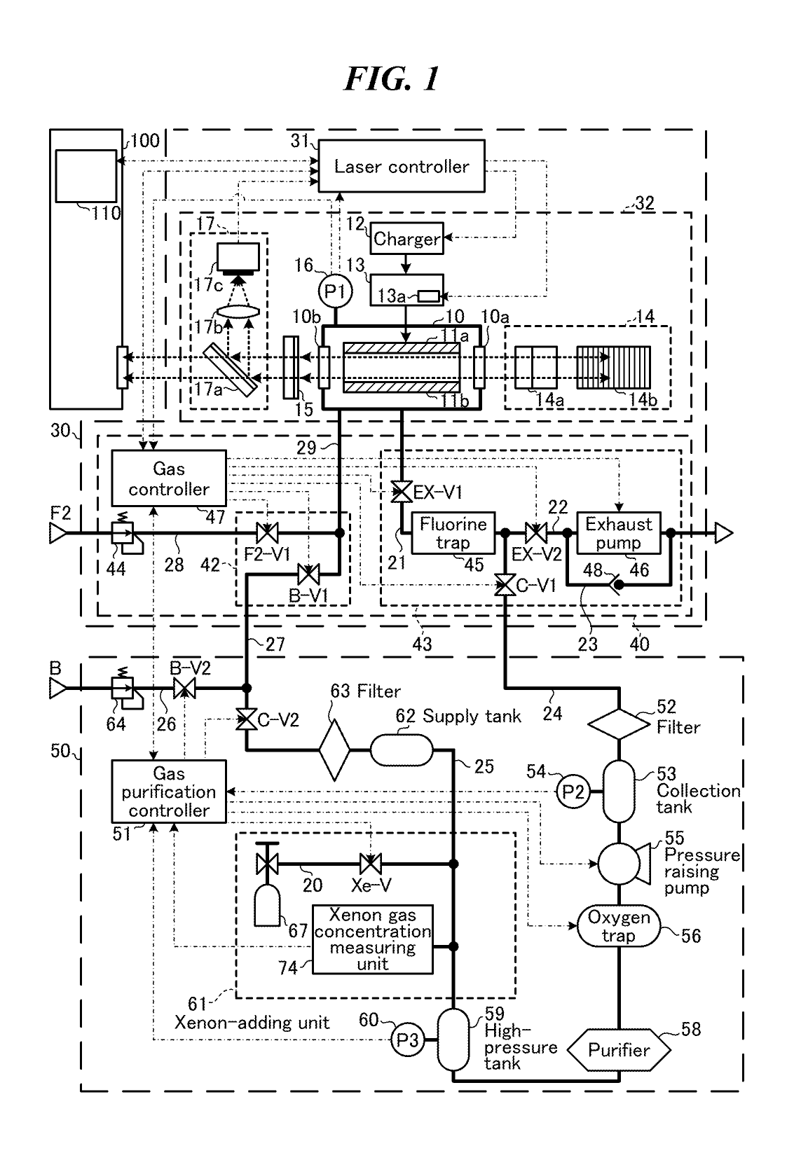

FIG. 1 schematically shows a configuration of an excimer laser apparatus 30 and a laser gas purifying system 50 according to a comparative example.

### 2.1.1 Excimer Laser Apparatus

The excimer laser apparatus 30 may include a laser controller 31, a laser oscillation system 32, and a laser gas control system 40.

The excimer laser apparatus 30 may be used with an exposure apparatus 100. A laser beam outputted from the excimer laser apparatus 30 may enter the exposure apparatus 100. The exposure apparatus 100 may include an exposure apparatus controller 110. The exposure apparatus controller 110 may be configured to control the exposure apparatus 100. The exposure apparatus controller 110 may be configured to send a setting signal of a target value of pulse energy and an oscillation trigger signal both to the laser controller 31 in the excimer laser apparatus 30.

The laser controller 31 may be configured to control the laser oscillation system 32 and the laser gas control system 40. The laser controller 31 may receive measured data from a power monitor 17 and a chamber pressure sensor 16 both included in the laser oscillation system 32.

### 2.1.1.1 Laser Oscillation System

The laser oscillation system 32 may include a chamber 10, a charger 12, a pulse power module 13, a line narrow module 14, an output coupling mirror 15, the chamber pressure sensor 16, and the power monitor 17.

The chamber 10 may be provided in an optical path in a laser resonator configured by the line narrow module 14 and the output coupling mirror 15. The chamber 10 may have two windows 10a and 10b. The chamber 10 may accommodate a pair of discharge electrodes 11a and 11b. The chamber 10 may accommodate the laser gas.

The charger 12 may hold electric energy to be supplied to the pulse power module 13. The pulse power module 13 may include a switch 13a. The pulse power module 13 may be configured to apply a pulsed voltage to the pair of discharge electrodes 11a and 11b.

The line narrow module 14 may include a prism 14a and a grating 14b. The output coupling mirror 15 may be a partially reflective mirror.

The chamber pressure sensor 16 may be configured to measure the pressure of the laser gas in the chamber 10. The pressure of the laser gas measured by the chamber pressure sensor 16 may be a total pressure of the laser gas. The chamber pressure sensor 16 may be configured to send the measured data of the pressure to the laser controller 31 and to a gas controller 47 included in the laser gas control system 40.

The power monitor 17 may include a beam splitter 17a, a focusing lens 17b, and an optical sensor 17c. The beam splitter 17a may be provided in the optical path of the laser beam outputted from the output coupling mirror 15. The beam splitter 17a may be configured to transmit a part of the laser beam outputted from the output coupling mirror 15 to the exposure apparatus 100 at a high transmittance and reflect another part. The focusing lens 17b and the optical sensor 17c may be provided in the optical path of the laser beam reflected by the beam splitter 17a. The focusing lens 17b may be configured to concentrate the laser beam reflected by the beam splitter 17a to the optical sensor 17c. The optical sensor 17c may be configured to send an electric signal according to the pulse energy of the laser beam concentrated by the focusing lens 17b as measured data to the laser controller 31.

### 2.1.1.2 Laser Gas Control System

The laser gas control system 40 may include the gas controller 47, a gas supply device 42, and an exhausting device 43. The gas controller 47 may send and receive signals to and from the laser controller 31. The gas controller 47 may receive the measured data outputted from the chamber pressure sensor 16 in the laser oscillation system 32. The gas controller 47 may be configured to control the gas supply device 42 and the exhausting device 43. The gas controller 47 may also be configured to control valves F2-V1 and B-V1 included in the gas supply device 42 and valves EX-V1, EX-V2, C-V1, and an exhaust pump 46 included in the exhausting device 43.

The gas supply device 42 may include a part of a pipe 28 connected to a fluorine-containing gas supply source F2 and a part of a pipe 29 connected to the chamber 10 in the laser oscillation system 32. Connecting the pipe 28 to the pipe 29 may allow the fluorine-containing gas supply source F2 to supply the fluorine-containing gas to the chamber 10. The fluorine-containing gas supply source F2 may be a gas cylinder that stores the fluorine-containing gas. The fluorine-containing gas may be laser gas where the fluorine gas, the argon gas, and the neon gas are mixed. Supply pressure of the laser gas from the fluorine-containing gas supply source F2 to the pipe 28 may be adjusted by a regulator 44. The gas supply device 42 may include the valve F2-V1 provided in the pipe 28. Supplying the fluorine-containing gas from the fluorine-containing gas supply source F2 via the pipe 29 to the chamber 10 may be controlled by opening and closing the valve F2-V1. Opening and closing of the valve F2-V1 may be controlled by the gas controller 47.

The gas supply device 42 may further include a part of a pipe 27 connected between the laser gas purifying system 50 and the pipe 29. Connecting the pipe 27 to the pipe 29 may allow the laser gas purifying system 50 to supply buffer gas to the chamber 10. The buffer gas may be laser gas including the argon gas, the neon gas, and a small amount of the xenon gas. The buffer gas may be new gas that is supplied by a buffer gas supply source B described below or purified gas where impurities are reduced by the laser gas purifying system 50. The gas supply device 42 may include the valve B-V1 provided in the pipe 27. Supplying the buffer gas from the laser gas purifying system 50 via the pipe 29 to the chamber 10 may be controlled by opening and closing the valve B-V1. Opening and closing of the valve B-V1 may be controlled by the gas controller 47.

The exhausting device 43 may include a part of a pipe 21 connected to the chamber 10 in the laser oscillation system 32 and a part of a pipe 22 connected to an unillustrated exhaust gas treating device or the like provided at outside of the exhausting device 43. Connecting the pipe 21 to the pipe 22 may allow emission gas emitted from the chamber 10 to be exhausted to the outside of the exhausting device 43.

The exhausting device 43 may further include the valve EX-V1 and a fluorine trap 45 both provided in the pipe 21. The valve EX-V1 and the fluorine trap 45 may be arranged in this order from a position near the chamber 10. Supplying the emission gas from the chamber 10 to the fluorine trap 45 may be controlled by opening and closing the valve EX-V1. Opening and closing of the valve EX-V1 may be controlled by the gas controller 47.

The fluorine trap 45 may be configured to catch fluorine gas and fluorine compound included in the emission gas emitted from the chamber 10. Treating agents to catch the fluorine gas and the fluorine compound may include, for example, a combination of zeolite and calcium oxide. The fluorine gas and the calcium oxide may react to form calcium fluoride and oxygen gas. The calcium fluoride may be adsorbed to the zeolite. The oxygen gas may be caught by an oxygen trap 56 described below.

The exhausting device 43 may include the valve EX-V2 and the exhaust pump 46 both provided in the pipe 22. The valve EX-V2 may be arranged nearer to the chamber 10 than the exhaust pump 46. Exhausting the emission gas from an outlet of the fluorine trap 45 to the outside of the exhausting device 43 may be controlled by opening and closing the valve EX-V2. Opening and closing of the valve EX-V2 may be controlled by the gas controller 47. When the valves EX-V1 and EX-V2 are open, the exhaust pump 46 may forcibly exhaust the laser gas in the chamber 10 to a pressure equal to or lower than the atmospheric pressure. Operation of the exhaust pump 46 may be controlled by the gas controller 47.

The exhausting device 43 may further include a bypass pipe 23 connected between the pipe 22 connected to an inlet of the exhaust pump 46 and the pipe 22 connected to an outlet of the exhaust pump 46. The exhausting device 43 may further include a check valve 48 provided in the bypass pipe 23. A part of the laser gas in the chamber 10 at a pressure equal to or higher than the atmospheric pressure may be exhausted by the check valve 48 when the valves EX-V1 and EX-V2 are open.

The exhausting device 43 may further include a part of a pipe 24. The pipe 24 may be connected between the laser gas purifying system 50 and a connecting portion connecting the pipe 21 and the pipe 22. Connecting the pipe 24 to the portion connecting the pipe 21 and the pipe 22 may allow the emission gas emitted from the chamber 10 to be supplied to the laser gas purifying system 50. The exhausting device 43 may further include the valve C-V1 provided in the pipe 24. Supplying the emission gas from the outlet of the fluorine trap 45 to the laser gas purifying system 50 may be controlled by opening and closing the valve C-V1. Opening and closing of the valve C-V1 may be controlled by the gas controller 47.

### 2.1.2 Laser Gas Purifying System

The laser gas purifying system 50 may include a gas purification controller 51. The gas purification controller 51 may send and receive signals to and from the gas controller 47 in the laser gas control system 40. The gas purification controller 51 may be configured to control each constituent element of the laser gas purifying system 50.

The laser gas purifying system 50 may include a part of the pipe 24 connected to the exhausting device 43 of the laser gas control system 40, a part of the pipe 27 connected to the gas supply device 42 of the laser gas control system 40, and a pipe 25 connected to a connecting portion connecting the pipes 24 and 27.

In the pipe 24 of the laser gas purifying system 50, a filter 52, a collection tank 53, a pressure raising pump 55, the oxygen trap 56, a purifier 58, and a high-pressure tank 59 may be arranged in this order from a position near the exhausting device 43. A xenon-adding unit 61 may be provided between the pipe 24 and the pipe 25. A supply tank 62, a filter 63, and a valve C-V2 may be arranged in this order in the pipe 25 from a position near the xenon-adding unit 61. The pipe 24 and the pipe 25 may configure a gas purification flow path from the valve C-V1 to the valve C-V2.

The laser gas purifying system 50 may further include a part of a pipe 26 connected to the buffer gas supply source B. The pipe 26 may be connected to a connecting portion connecting the pipes 25 and 27. The buffer gas supply source B may be a gas cylinder that stores buffer gas. In the present disclosure, buffer gas supplied from the buffer gas supply source B and have not reached the chamber 10 may be referred to as “new gas”, in contrast to the purified gas supplied from the pipes 24 and 25. Supply pressure of the new gas from the buffer gas supply source B to the pipe 26 may be adjusted by a regulator 64. The laser gas purifying system 50 may include a valve B-V2 provided in the pipe 26.

The filter 52 included in the laser gas purifying system 50 may catch particles included in the emission gas.

The collection tank 53 may be a container to store the emission gas. A pressure sensor 54 may be equipped with the collection tank 53.

The pressure raising pump 55 may be configured to raise the pressure of the emission gas and output the emission gas. The pressure raising pump 55 may be a diaphragm pump, which may generate little oil contaminant. The pressure raising pump 55 may be controlled by the gas purification controller 51.

The oxygen trap 56 may be configured to catch the oxygen gas. Treating agent to catch the oxygen gas may include at least one of nickel-based (Ni-based) catalyst, copper-based (Cu-based) catalyst, and a composite thereof. The oxygen trap 56 may include an unillustrated heating device and an unillustrated temperature regulator. The heating device and the temperature regulator of the oxygen trap 56 may be controlled by the gas purification controller 51.

The purifier 58 may be a metal filter including metal getter. The metal getter may be zirconium-based (Zr-based) alloy. The purifier 58 may be configured to trap gaseous impurities from the laser gas.

The high-pressure tank 59 may be a container to store the purified gas that has passed through the flow path from the fluorine trap 45 to the purifier 58. A pressure sensor 60 may be equipped with the high-pressure tank 59.

The xenon-adding unit 61 may include a xenon gas concentration measuring unit 74 connected to the pipe 24, a xenon-containing gas cylinder 67, a pipe 20 connected to the xenon-containing gas cylinder 67, and a valve Xe-V provided in the pipe 20. The pipe 20 may be connected to a connecting portion connecting the pipes 24 and 25.

The xenon gas concentration measuring unit 74 may be, for example, a gas chromatograph mass spectrometer.

The xenon-containing gas cylinder 67 may store xenon-containing gas. The xenon-containing gas may be laser gas where the argon gas, the neon gas, and the xenon gas are mixed. The concentration of the xenon gas in the xenon-containing gas may be higher than an optimum concentration of the xenon gas for an ArF excimer laser apparatus. Supplying the xenon-containing gas from the xenon-containing gas cylinder 67 via the pipe 20 to the supply tank 62 may be controlled by opening and closing the valve Xe-V. Opening and closing of the valve Xe-V may be controlled by the gas purification controller 51.

The supply tank 62 provided in the pipe 25 may be a container to store the purified gas.

The filter 63 may catch particles from the purified gas.

### 2.2 Operation

### 2.2.1 Operation of Excimer Laser Apparatus

### 2.2.1.1 Operation of Laser Oscillation System

The laser controller 31 may receive the setting signal of the target value of pulse energy and the oscillation trigger signal from the exposure apparatus controller 110. The laser controller 31 may send a setting signal of charging voltage to the charger 12 based on the setting signal of the target value of pulse energy received from the exposure apparatus controller 110. The laser controller 31 may also send an oscillation trigger to the switch 13a in the pulse power module (PPM) 13 based on the oscillation trigger signal received from the exposure apparatus controller 110.

The switch 13a in the pulse power module 13 may turn ON upon receiving the oscillation trigger from the laser controller 31. The pulse power module 13 where the switch 13a has turned ON may generate a pulsed high voltage from the electric energy charged in the charger 12 and apply the high voltage to the pair of discharge electrodes 11a and 11b.

The high voltage applied to the pair of discharge electrodes 11a and 11b may cause an electric discharge between the pair of discharge electrodes 11a and 11b. The energy of the electric discharge may excite the laser gas in the chamber 10 and the laser gas may shift to a high energy level. The excited laser gas may then shift back to a low energy level to emit light having a wavelength according to the difference in the energy levels.

The light generated in the chamber 10 may be emitted via the windows 10a and 10b to the outside of the chamber 10. The light emitted from the chamber 10 via the window 10a may be beam-expanded by the prism 14a and be incident on the grating 14b. The light incident on the grating 14b from the prism 14a may be reflected by a plurality of grooves of the grating 14b, being diffracted in directions according to the wavelengths of the light. The grating 14b may be in a Littrow arrangement such that an angle of incidence of the light incident on the grating 14b from the prism 14a and an angle of diffraction of diffracted light having a desired wavelength coincide with each other. The light around the desired wavelength may thus return via the prism 14a to the chamber 10.

The output coupling mirror 15 may transmit and output a part of the light emitted from the window 10b of the chamber 10 and reflect and return another part of the light to the chamber 10.

The light emitted from the chamber 10 may thus reciprocate between the line narrow module 14 and the output coupling mirror 15. The light may be amplified each time it passes through the electric discharge space between the pair of discharge electrodes 11a and 11b, which causes laser oscillation. The light may be narrow-banded each time it is returned by the line narrow module 14. The light thus amplified and narrow-banded may be outputted from the output coupling mirror 15 as the laser beam.

The power monitor 17 may detect the pulse energy of the laser beam outputted from the output coupling mirror 15. The power monitor 17 may send the data on the detected pulse energy to the laser controller 31.

The laser controller 31 may perform feedback control of the charging voltage set to the charger 12. The feedback control may be based on the measured data on the pulse energy received from the power monitor 17 and the setting signal of the target value of pulse energy received from the exposure apparatus controller 110.

### 2.2.1.2 Operation of Laser Gas Control System

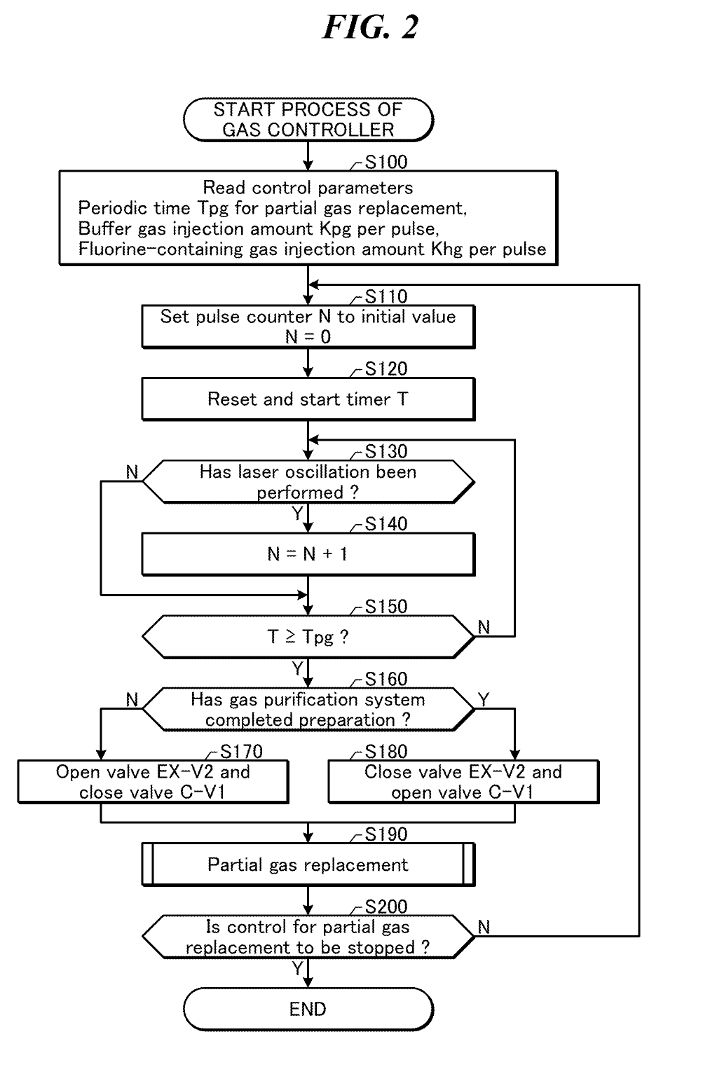

FIG. 2 is a flowchart showing a process of the gas controller 47 in the excimer laser apparatus 30 according to the comparative example. The laser gas control system 40 of the excimer laser apparatus 30 may perform a partial gas replacement in the process described below executed by the gas controller 47.

First, at S100, the gas controller 47 may read various control parameters. The control parameters may include, for example, a periodic time Tpg for the partial gas replacement, a buffer gas injection amount Kpg per pulse, and a fluorine-containing gas injection amount Khg per pulse.

Next, at S110, the gas controller 47 may set a pulse counter N to an initial value 0.

Next, at S120, the gas controller 47 may reset and start a timer T, to be used for deciding expiration of the periodic time for the partial gas replacement.

Next, at S130, the gas controller 47 may determine whether laser oscillation has been performed. Whether the laser oscillation has been performed may be determined by receiving the oscillation trigger from the laser controller 31 or receiving the data measured by the power monitor 17 from the laser controller 31.

If the laser oscillation has been performed (S130: YES), the gas controller 47 may add 1 to the value of the pulse counter N at S140 to update the value of N, and proceed to S150. If the laser oscillation is not performed in a predetermined period of time (S130: NO), the gas controller 47 may skip S140 to proceed to S150.

At S150, the gas controller 47 may determine whether the value of the timer T has reached the periodic time Tpg for the partial gas replacement. If the value of the timer T has reached the periodic time Tpg (S150: YES), the gas controller 47 may proceed to S160. If the value of the timer T has not reached the periodic time Tpg (S150: NO), the gas controller 47 may return to S130 to repeat the sequence of updating the number of pulses and determining the periodic time Tpg.

At S160, the gas controller 47 may determine whether the laser gas purifying system has completed its preparation. The determination may be made based on a signal to show completion of preparation for gas purification or a signal to show suspension of gas purification, whichever is received from the gas purification controller 51. The gas controller 47 may select, according to the determination, one of the following controls: a first control to close the valve C-V1 and open the EX-V2, and a second control to close the valve EX-V2 and open the valve C-V1. Namely, if the laser gas purifying system has not completed its preparation (S160: NO), the gas controller 47 may perform the first control described above at S170 and proceed to 3190. If the laser gas purifying system has completed its preparation (S160: YES), the gas controller 47 may perform the second control described above at S180 and proceed to S190.

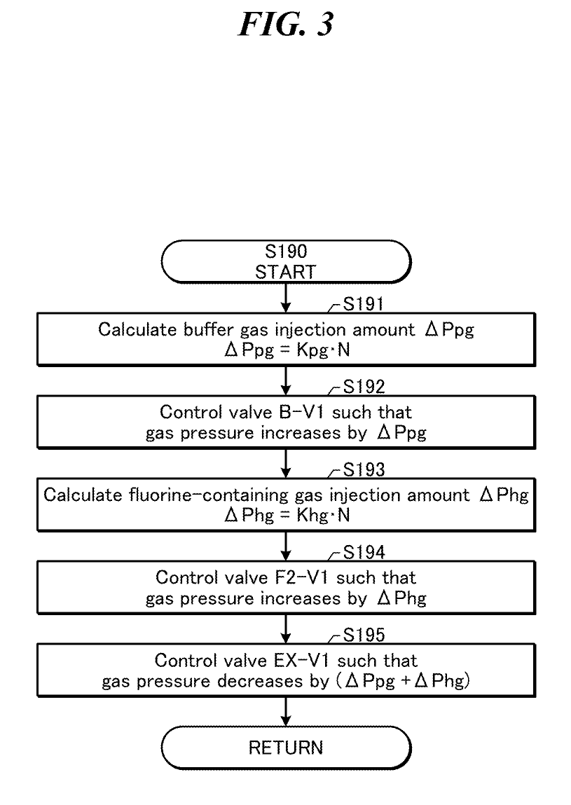

At S190, the gas controller 47 may execute the partial gas replacement. Details of the process of S190 will be described below with reference to FIG. 3.

After executing the partial gas replacement, the gas controller 47 may determine at S200 whether the control for the partial gas replacement is to be stopped. If the control for the partial gas replacement is to be stopped (S200: YES), the gas controller 47 may end the process of this flowchart. If the control for the partial gas replacement is not to be stopped (S200: NO), the gas controller 47 may return to S110 described above. The gas controller 47 may then reset the pulse counter N and the timer T to re-start counting the number of pulses to determine the periodic time Tpg.

FIG. 3 is a flowchart showing details of the process of S190 shown in FIG. 2. The gas controller 47 may execute the partial gas replacement as described below.

First, at S191, the gas controller 47 may calculate a buffer gas injection amount ΔPpg by the following formula.

ΔPpg=Kpg·N

Here, Kpg is the buffer gas injection amount per pulse described above. N is the value of the pulse counter.

Next, at S192, the gas controller 47 may open the valve B-V1 to inject the buffer gas supplied from the laser gas purifying system 50 into the chamber 10. The buffer gas supplied from the laser gas purifying system 50 may be the new gas supplied from the buffer gas supply source B via the valve B-V2 or the purified gas where impurities are reduced in the laser gas purifying system 50 and supplied via the valve C-V2.

The gas controller 47 may receive the measured data from the chamber pressure sensor 16. If an amount of increase in pressure of the laser gas in the chamber 10 has reached an amount of increase corresponding to the buffer gas injection amount ΔPpg, the gas controller 47 may close the valve B-V1.

Next, at S193, the gas controller 47 may calculate a fluorine-containing gas injection amount ΔPhg by the following formula.

ΔPhg−Khg·N

Here, Khg may be the fluorine-containing gas injection amount per pulse described above.

Next, at S194, the gas controller 47 may open the valve F2-V1 to inject the fluorine-containing gas supplied from the fluorine-containing gas supply source F2 into the chamber 10.

The gas controller 47 may receive the measured data from the chamber pressure sensor 16. If an amount of increase in pressure of the laser gas in the chamber 10 has reached an amount of increase corresponding to the fluorine-containing gas injection amount ΔPhg, the gas controller 47 may close the valve F2-V1.

Next, at S195, the gas controller 47 may open and close the valve EX-V1 to emit a part of the laser gas in the chamber 10 to the exhausting device 43. If the gas controller 47 has recently performed the first control in S170 described above, the emission gas emitted from the chamber 10 to the exhausting device 43 may be exhausted via the valve EX-V2 to the outside of the exhausting device 43. If the gas controller 47 has recently performed the second control at S180 described above, the emission gas emitted from the chamber 10 to the exhausting device 43 may be supplied to the laser gas purifying system 50 via the valve C-V1.

The gas controller 47 may receive the measured data from the chamber pressure sensor 16. The gas controller 47 may repeat opening and closing of the valve EX-V1 until an amount of decrease in pressure of the laser gas in the chamber 10 reaches an amount of decrease corresponding to the sum of the buffer gas injection amount ΔPpg and the fluorine-containing gas injection amount ΔPhg.

After S195, the gas controller 47 may end the process of this flowchart and return to the process shown in FIG. 2.

In the partial gas replacement described above, a predetermined amount of gas with a reduced amount of impurities may be supplied to the chamber 10 and an amount of gas equivalent to the predetermined amount may be exhausted from the chamber 10. Impurities in the chamber 10 such as hydrogen fluoride (HF), tetrafluoromethane (CF₄), silicon tetrafluoride (SiF₄), nitrogen trifluoride (NF₃), and hexafluoroethane (C₂F₆) may thus be reduced.

### 2.2.2 Operation of Laser Gas Purifying System

The filter 52 may catch particles, having been generated by the electric discharge in the chamber 10, included in the emission gas passed through the fluorine trap 45.

The collection tank 53 may store the emission gas passed through the filter 52. The pressure sensor 54 may measure the pressure in the collection tank 53. The pressure sensor 54 may send data on the measured gas pressure to the gas purification controller 51.

The pressure raising pump 55 may raise the pressure of the emission gas from the collection tank 53 to output the emission gas to the oxygen trap 56. While the value of the pressure in the collection tank 53 received from the pressure sensor 54 is equal to or higher than the atmospheric pressure, the gas purification controller 51 may keep the pressure raising pump 55 operated.

The oxygen trap 56 may catch the oxygen gas generated in the fluorine trap 45 by the reaction of the fluorine gas and the calcium oxide.

The purifier 58 may trap gaseous impurities such as a small amount of water vapor, oxygen gas, carbon monoxide gas, carbon dioxide gas, nitrogen gas, or the like from the emission gas passed through the oxygen trap 56.

The high-pressure tank 59 may store the purified gas passed through the purifier 58. The pressure sensor 60 may measure the pressure in the high-pressure tank 59. The pressure sensor 60 may send data on the measured gas pressure to the gas purification controller 51.

The xenon gas concentration measuring unit 74 may measure the xenon gas concentration in the purified gas supplied from the high-pressure tank 59. The xenon gas concentration measuring unit 74 may send data on the measured xenon gas concentration to the gas purification controller 51.

The gas purification controller 51 may calculate an amount of gas to be supplied from the xenon-containing gas cylinder 67 based on the xenon gas concentration received from the xenon gas concentration measuring unit 74. The amount of gas to be supplied may be calculated such that purified gas with a desired xenon gas concentration is supplied to the pipe 25. The gas purification controller 51 may control the valve Xe—V based on the calculated amount of gas. The purified gas supplied from the high-pressure tank 59 via the pipe 24 may be joined with the xenon-containing gas passed through the valve Xe-V and be supplied to the pipe 25.

The supply tank 62 may store the purified gas supplied from the xenon-adding unit 61.

The filter 63 may catch particles, having been generated in the laser gas purifying system 50, included in the purified gas supplied from the supply tank 62.

Supplying the purified gas from the gas purification flow path via the pipe 27 to the gas supply device 42 may be controlled by opening and closing the valve C-V2. Opening and closing of the valve C-V2 may be controlled by the gas purification controller 51.

Supplying the new gas from the buffer gas supply source B via the pipe 27 to the gas supply device 42 may be controlled by opening and closing the valve B-V2. Opening and closing of the valve B-V2 may be controlled by the gas purification controller 51.

The gas purification controller 51 may select one of the following controls: closing the valve C-V2 and opening the valve B-V2, and closing the valve B-V2 and opening the valve C-V2.

### 2.3 Problem

Xenon gas concentration in the laser gas in the ArF excimer laser apparatus may be, for example, around 10 ppm. Xenon gas may react with fluorine gas in the chamber 10 to form xenon fluoride. The xenon gas concentration in the chamber 10 may thus be slightly reduced. Repeating re-use of the purified gas may cause the xenon gas concentration to be further reduced. An optimum range of the xenon gas concentration in an ArF excimer laser apparatus may be so narrow that slightly reducing the xenon gas concentration may affect the laser performance.

It may be possible to measure the xenon gas concentration and supply a shortage as described above in the comparative example. However, the mass spectrometer to measure the xenon gas concentration is a large-scale high-priced apparatus, which may be disadvantageous in space for installation and costs.

Alternatively, it may be possible to add xenon gas if the laser performance has worsened. However, such measures may be possible only after the laser performance worsens, which may be disadvantageous in laser performance.

The embodiments described below may remove xenon gas by a xenon trap 57 and add a small amount of xenon gas to achieve a desired xenon gas concentration. This may reduce the space for installation and costs and improve the stability of laser performance.

### 3. Laser Gas Purifying System Including Xenon Trap

### 3.1 Configuration

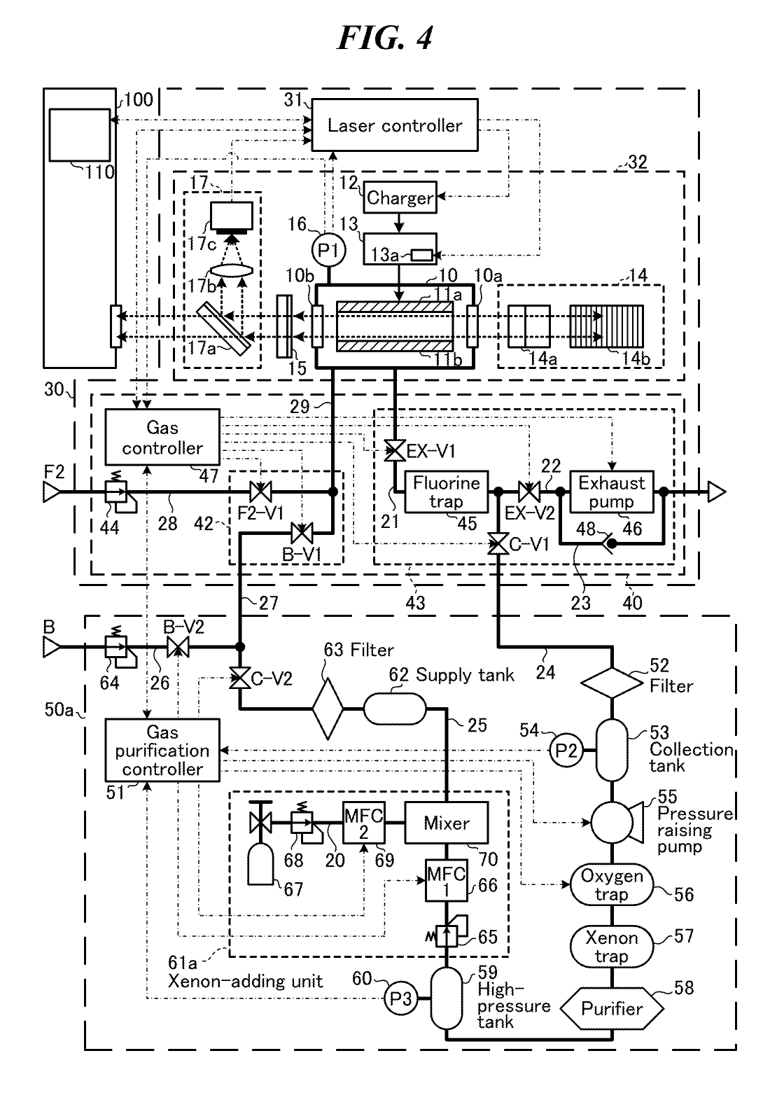

FIG. 4 schematically shows a configuration of an excimer laser apparatus 30 and a laser gas purifying system 50a according to a first embodiment of the present disclosure. In the first embodiment, the laser gas purifying system 50a may include the xenon trap 57 in the pipe 24 between the oxygen trap 56 and the purifier 58.

A xenon-adding unit 61a in the first embodiment may include regulators 65 and 68, mass-flow controllers 66 and 69, and a mixer 70. The xenon gas concentration measuring unit 74 and the valve Xe-V described above with reference to FIG. 1 may be omitted.

The regulator 65 and the mass-flow controller 66 may be arranged in the pipe 24. The regulator 65 and the mass-flow controller 66 may be arranged in this order from a position near the high-pressure tank 59. The regulator 68 and the mass-flow controller 69 may be arranged in the pipe 20. The regulator 68 and the mass-flow controller 69 may be arranged in this order from a position near the xenon-containing gas cylinder 67. The mixer 70 may be arranged in a joining position of the pipe 24 and the pipe 20. An output of the mixer 70 may be connected to the pipe 25.

In other aspects, the configuration of the first embodiment may be substantially the same as the configuration of the comparative example described with reference to FIG. 1.

### 3.2 Operation

The xenon trap 57 may remove xenon gas from the emission gas passed through the oxygen trap 56. “Removing” xenon gas may not necessarily mean reducing xenon gas concentration to 0. It may mean reducing xenon gas concentration to decrease variation in the xenon gas concentration.

The regulator 65 may regulate the pressure of the purified gas supplied from the high-pressure tank 59 to a predetermined value to supply the purified gas to the mass-flow controller 66. The mass-flow controller 66 may control the flow rate of the purified gas supplied from the regulator 65 to a predetermined value.

The regulator 68 may regulate the pressure of the xenon-containing gas supplied from the xenon-containing gas cylinder 67 to a predetermined value to supply the xenon-containing gas to the mass-flow controller 69. The mass-flow controller 69 may control the flow rate of the xenon-containing gas supplied from the regulator 68 to a predetermined value.

The flow rate of the mass-flow controller 66 and the flow rate of the mass-flow controller 69 may be set by the gas purification controller 51 such that the xenon gas concentration in the purified gas mixed by the mixer 70 is kept to a desired value.

The mixer 70 may uniformly mix the purified gas supplied from the mass-flow controller 66 with the xenon-containing gas supplied from the mass-flow controller 69. The purified gas mixed with the xenon-containing gas by the mixer 70 may be supplied via the pipe 25 to the supply tank 62.

### 3.3 Process of Gas Purification Controller

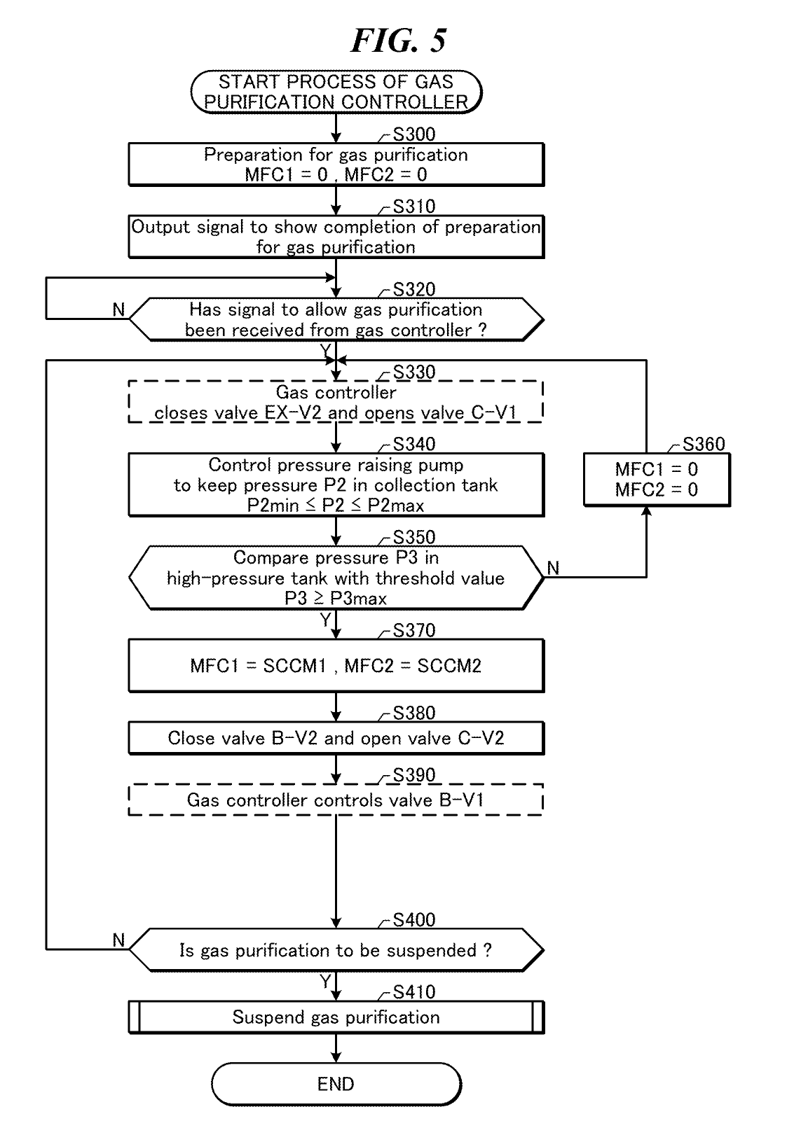

FIG. 5 is a flowchart showing a process of the gas purification controller 51 of the laser gas purifying system 50a according to the first embodiment. The laser gas purifying system 50a may perform the gas purification in the process described below executed by the gas purification controller 51. In addition to the gas purification shown in FIG. 5, the partial gas replacement described with reference to FIGS. 2 and 3 may also be performed in the first embodiment by the gas controller 47.

First, at S300, the gas purification controller 51 may perform the preparation for gas purification. Here, the flow rate MFC1 of the mass-flow controller 66 and the flow rate MFC2 of the mass-flow controller 69 may each be set to 0. Further, the valve C-V2 may be kept closed and the valve B-V2 may be kept open. Until the gas purification controller 51 outputs the signal to show completion of preparation for gas purification described below, the gas controller 47 may keep the valve C-V1 closed. The preparation for gas purification may include, for example, filling the pipes and the tanks in the laser gas purifying system 50a with laser gas or exhausting gas by an unillustrated exhaust pump to a pressure equal to or lower than the atmospheric pressure. The preparation for gas purification may further include heating the oxygen trap 56 to an optimum temperature to accelerate the oxygen adsorption.

After completing the preparation for gas purification, the gas purification controller 51 may output at S310 the signal to show completion of preparation for gas purification to the gas controller 47.

Next, at S320, the gas purification controller 51 may determine whether it has received a signal to allow gas purification from the gas controller 47. The gas purification controller 51 may wait until receiving the signal to allow gas purification from the gas controller 47.

The gas controller 47 may output the signal to allow gas purification and then close the valve EX-V2 and open the valve C-V1 (S330) in the process of S180 in FIG. 2. Thus, the emission gas emitted from the chamber 10 to the exhausting device 43 may flow into the laser gas purifying system 50a.

Next, at S340, the gas purification controller 51 may control the pressure raising pump 55 to keep the pressure P2 in the collection tank 53 in the following range.

P2min≤P2≤P2max

P2 min may be, for example, a value equivalent to the atmospheric pressure. P2max may be a value higher than the atmospheric pressure.

Next, at S350, the gas purification controller 51 may compare the pressure P3 in the high-pressure tank 59 with a threshold value P3max. The threshold value P3max may be higher than the pressure in the chamber 10. The threshold value P3max may be equivalent to the pressure of the regulator 64 for the buffer gas supply source B.

If the pressure P3 in the high-pressure tank 59 is equal to or higher than the threshold value P3max (S350: YES), the gas purification controller 51 may proceed to S370 described below to allow the gas to flow through the mass-flow controller. If the pressure P3 of the high-pressure tank 59 is lower than the threshold value P3max (S350: NO), the gas purification controller 51 may set, at S360, the flow rate MFC1 of the mass-flow controller 66 and the flow rate MFC2 of the mass-flow controller 69 both to 0. After 8360, the gas purification controller 51 may return to S330 and continue driving the pressure raising pump 55 in 8340. Control of the valves EX-V2 and C-V1 at S330 may be kept unchanged.

At S370, the gas purification controller 51 may set the flow rate MFC1 of the mass-flow controller 66 to SCCM1 and set the flow rate MFC2 of the mass-flow controller 69 to SCCM2. SCCM1 and SCCM2 may be values where the purified gas mixed with the xenon-containing gas has the desired xenon gas concentration.

Next, at S380, the gas purification controller 51 may close the valve B-V2 and open the valve C-V2. Instead of the new gas from the buffer gas supply source B, the purified gas where impurities are reduced in the laser gas purifying system 50a may thus be supplied to the excimer laser apparatus 30.

The gas controller 47 may then control the valve B-V1 (S390) in the process of S192 in FIG. 3. If the process of S192 in FIG. 3 is performed after 8380, the purified gas may be supplied via the valve C-V2 to the excimer laser apparatus 30. If the process of S192 in FIG. 3 is performed before S380, the new gas may be supplied via the valve B-V2 to the excimer laser apparatus 30.

Next, at S400, the gas purification controller 51 may determine whether the gas purification is to be suspended. If the gas purification is not to be suspended (S400: NO), the gas purification controller 51 may return to S330. Control of the valves EX-V2 and C-V1 at S330 may be kept unchanged. If the gas purification is to be suspended (S400: YES), the gas purification controller 51 may proceed to S410.

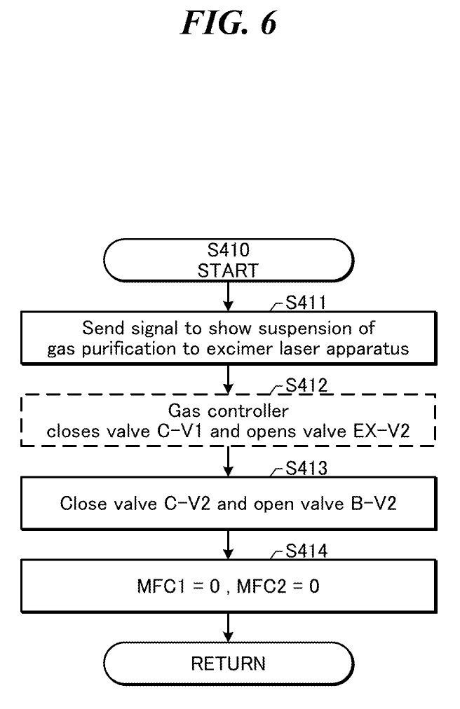

At S410, the gas purification controller 51 may execute a process to suspend the gas purification. Details of S410 are described below with reference to FIG. 6.

FIG. 6 is a flowchart showing details of the process of S410 shown in FIG. 5. The gas purification controller 51 may suspend the gas purification in the process described below.

First, at S411, the gas purification controller 51 may send a signal to show suspension of gas purification to the excimer laser apparatus 30. The signal to show suspension of gas purification may cancel the signal to show completion of preparation for gas purification described above with reference to FIG. 5.

The gas controller 47 may close the valve C-V1 and open the valve EX-V2 (S412) in the process of S170 in FIG. 2. Then, the emission gas emitted from the chamber 10 to the exhausting device 43 may be exhausted to the outside of the exhausting device 43 without flowing into the laser gas purifying system 50a.

Next, at S413, the gas purification controller 51 may close the valve C-V2 and open the valve B-V2. The new gas from the buffer gas supply source B may thus be supplied to the excimer laser apparatus 30.

Next, at S414, the gas purification controller 51 may set the flow rate MFC1 of the mass-flow controller 66 and the flow rate MFC2 of the mass-flow controller 69 both to 0.

After S414, the gas purification controller 51 may end the process of this flowchart to return to the process shown in FIG. 5.

### 3.4 Supplementary Explanation

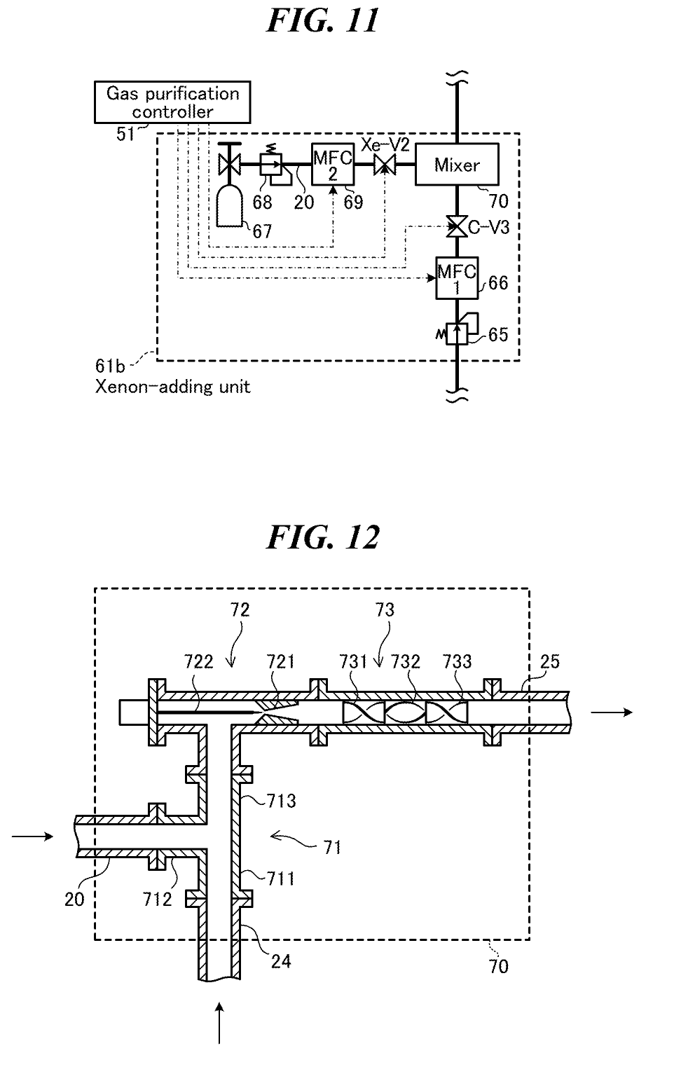

In the first embodiment, the setting value of the flow rate of the mass-flow controller 66 is switched between 0 and SCCM1, whereas the setting value of the flow rate of the mass-flow controller 69 is switched between 0 and SCCM2. However, the present disclosure is not limited to this. Unillustrated valves may be arranged downstream from the respective mass-flow controllers 66 and 69. The setting values of the flow rates of the mass-flow controllers 66 and 69 may be fixed to SCCM1 and SCCM2, respectively. While the unillustrated valves are closed, the flow rates may each be 0. This configuration is described below with reference to FIG. 11.

In the first embodiment, the gas controller 47 and the gas purification controller 51 send the signals directly to each other. However, the present disclosure is not limited to this. The gas controller 47 may receive the signals from the gas purification controller 51 via the laser controller 31. The gas purification controller 51 may receive the signals from the gas controller 47 via the laser controller 31.

In the first embodiment, the fluorine trap 45 is provided in the pipe 21. However, the present disclosure is not limited to this. Instead of the fluorine trap 45, unillustrated fluorine traps may be provided in the respective pipes 22 and 24. The unillustrated fluorine trap in the pipe 22 may be provided upstream from the exhaust pump 46. The unillustrated fluorine trap in the pipe 24 may be provided upstream from the filter 52.

In the first embodiment, the treating agent filled in the fluorine trap 45 is the combination of zeolite and calcium oxide. However, the present disclosure is not limited to this. The treating agent filled in the fluorine trap 45 may be a combination of zeolite and calcium hydroxide.

The treating agent filled in the fluorine trap 45 may be alkaline earth metal such as calcium. If the treating agent filled in the fluorine trap 45 is alkaline earth metal, the fluorine trap 45 may be equipped with a heating device. If the treating agent filled in the fluorine trap 45 is alkaline earth metal, the oxygen trap 56 may be replaced by a container filled with zirconium-based (Zr-based) metal. The container filled with zirconium-based metal may be equipped with a heating device.

### 3.5 Effect

According to the first embodiment, the purified gas where xenon gas is removed may be mixed with the xenon-containing gas supplied from the xenon-containing gas cylinder. The xenon gas concentration in the purified gas where xenon gas is removed may be approximated according to performance of the xenon trap 57. For example, the xenon gas concentration in the purified gas where xenon gas is removed may be substantially 0. Meanwhile, the xenon gas concentration in the xenon-containing gas supplied from the xenon-containing gas cylinder may be already known. A mixing ratio of the purified gas and the xenon-containing gas may be set to control the xenon gas concentration in the mixed gas in a preferable range.

According to the above, the stability in the laser performance may improve.

Further, the xenon gas concentration measuring unit may be omitted. This may allow the space for installation to be compact and the laser gas purifying system to be low-priced.

The inert gas such as argon gas and neon gas may be recycled, which may improve the lifetime of the gas and reduce costs for the inert gas. Although new xenon-containing gas may be necessary to compensate for the removed xenon gas, an optimum amount of the xenon gas may be small for an ArF excimer laser. This may avoid a significant increase in costs for the xenon gas.

### 4. Laser Gas Purifying System Connected to Plurality of Laser Apparatuses

### 4.1 Configuration

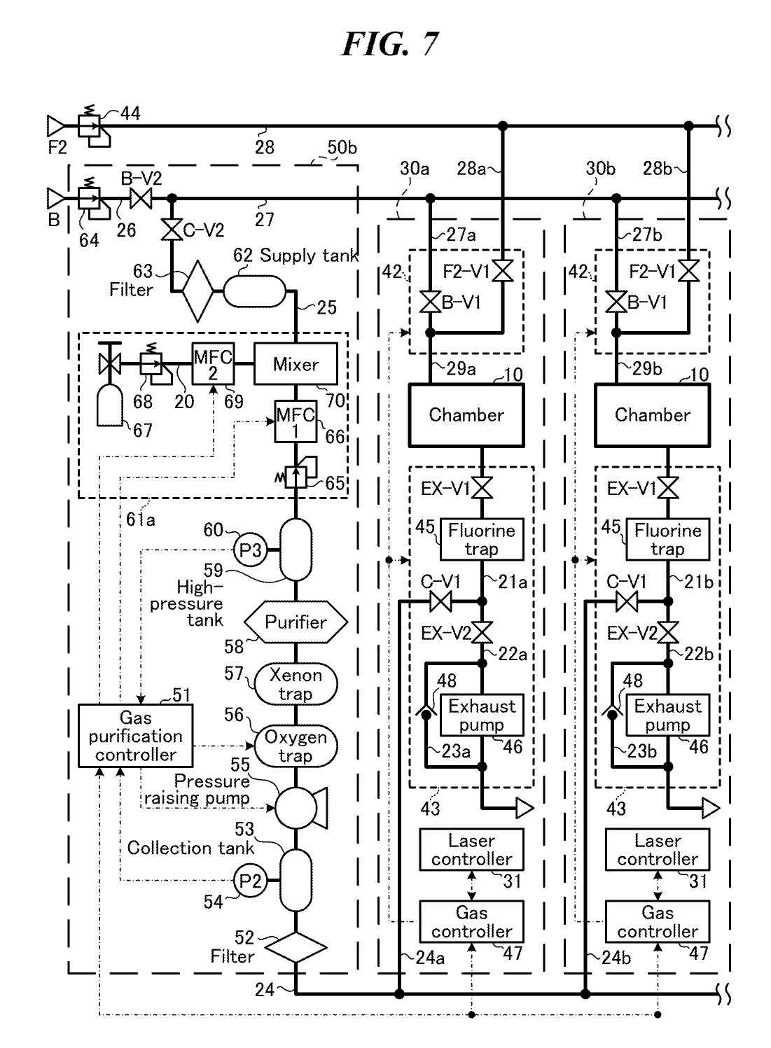

FIG. 7 schematically shows a configuration of excimer laser apparatuses 30a and 30b and a laser gas purifying system 50b according to a second embodiment of the present disclosure. In the second embodiment, the laser gas purifying system 50b may be connected to a plurality of excimer laser apparatuses. The laser gas purifying system 50b may reduce impurities in the gas emitted from each of the excimer laser apparatuses and supply purified gas, where impurities are reduced, to each of the excimer laser apparatuses. The configuration of each of the excimer laser apparatuses 30a and 30b may be substantially the same as the configuration of the excimer laser apparatus 30 of the first embodiment.

The pipe 24 in the laser gas purifying system 50b may be branched at upstream from the filter 52 to pipes 24a and 24b for the respective excimer laser apparatuses. The valve C-V1 may be provided in each of the pipes 24a and 24b. Opening and closing of the valve C-V1 may achieve control of supplying the emission gas from the exhausting device 43 included in each of the excimer laser apparatuses 30a and 30b to the laser gas purifying system 50b.

The pipe 27 to supply the buffer gas to the excimer laser apparatuses may be branched to pipes 27a and 27b for the respective excimer laser apparatuses. The valve B-V1 may be provided in each of the pipes 27a and 27b. Opening and closing of the valve B-V1 may achieve control of supplying the buffer gas to the gas supply device 42 in each of the excimer laser apparatuses 30a and 30b.

The pipe 28 to supply the fluorine-containing gas to the excimer laser apparatuses may be branched to pipes 28a and 28b for the respective excimer laser apparatuses. The valve F2-V1 may be provided in each of the pipes 28a and 28b. Opening and closing of the valve F2-V1 may achieve control of supplying the fluorine-containing gas to the gas supply device 42 in each of the excimer laser apparatuses 30a and 30b.

The gas purification controller 51 may be connected via a signal line to the gas controller 47 in each of the excimer laser apparatuses 30a and 30b.

In other aspects, the second embodiment may be substantially the same as the first embodiment.

### 4.2 Operation

The operation of each of the excimer laser apparatuses 30a and 30b may be substantially the same as the operation of the excimer laser apparatus 30a of the first embodiment.

The laser gas purifying system 50b may reduce impurities in the emission gas emitted from each of the excimer laser apparatuses 30a and 30b and supply the purified gas, where impurities are reduced, to each of the excimer laser apparatuses 30a and 30b. In other aspects, the operation of the laser gas purifying system 50b may be substantially the same as that of the laser gas purifying system 50a in the first embodiment.

The laser gas purifying system 50b may receive the emission gas emitted from the excimer laser apparatuses 30a and 30b, either in parallel or in sequence. The laser gas purifying system 50b may supply the buffer gas to the excimer laser apparatuses 30a and 30b, either in parallel or in sequence.

The laser gas purifying system 50b may supply the new gas to the excimer laser apparatus 30a and supply the purified gas to the other excimer laser apparatus 30b, which may be performed in sequence rather than in parallel.

### 4.3 Effect

According to the second embodiment, the laser gas purifying system 50b may purify the emission gas emitted from the excimer laser apparatuses and supply the purified gas to the excimer laser apparatuses. The amount of consumption of the inert gas and running cost of the excimer laser apparatuses may thus be reduced. Further, the purified gas having an optimum xenon gas concentration may be supplied to the excimer laser apparatuses, which may stabilize the performance of the excimer laser apparatuses. Furthermore, a single laser gas purifying system 50b is installed for the excimer laser apparatuses, which may allow the space for installation and the equipment cost to be reduced.

### 5. Laser Gas Purifying System that Determines End of Lifetime of Xenon Trap

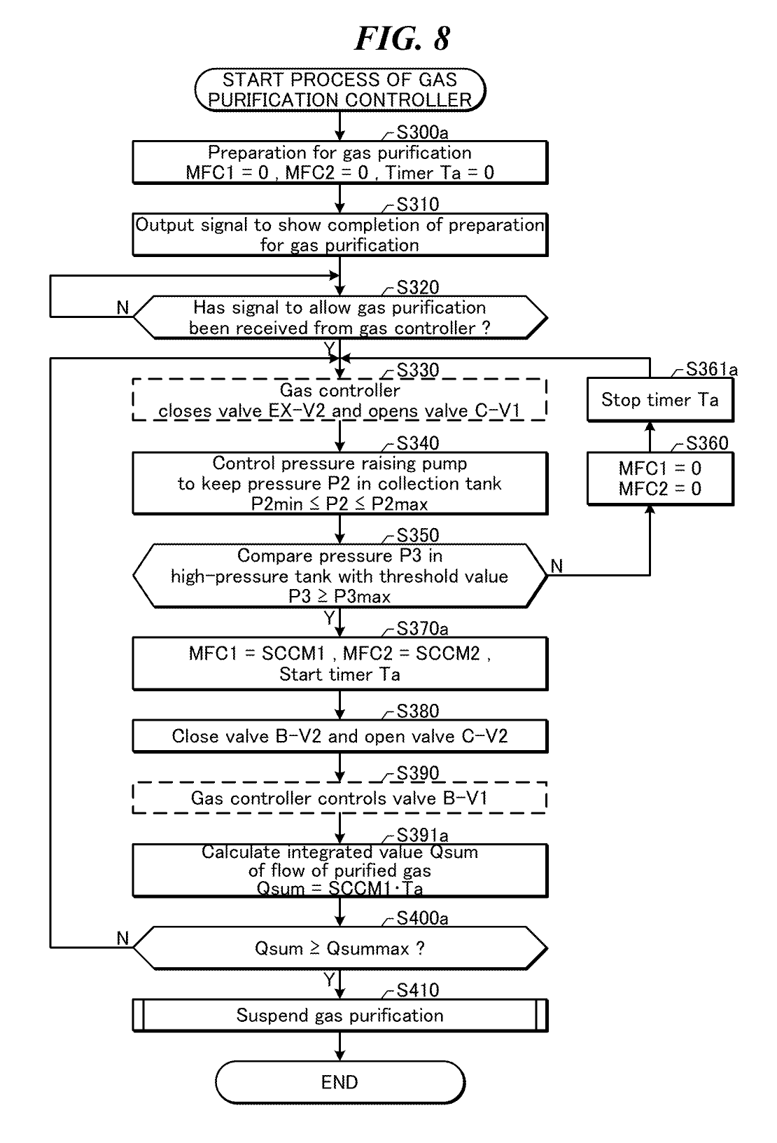

FIG. 8 is a flowchart showing a process of a gas purification controller in a laser gas purifying system according to a third embodiment of the present disclosure. The laser gas purifying system according to the third embodiment may have substantially the same configuration with the laser gas purifying system 50a described above with reference to FIG. 4. The laser gas purifying system according to the third embodiment may determine the end of the lifetime of the xenon trap 57 in the process described as follows.

First, in the preparation for gas purification at S300a, the gas purification controller 51 may set the timer Ta to 0. In other aspects, S300a may be substantially the same as S300 in FIG. 5. The process from S310 to S350 may be substantially the same as the process of the corresponding step numbers in FIG. 5.

At the start of flowing of the gas through the mass-flow controller at S370a, the gas purification controller 51 may start the timer Ta. In other aspects, S370a may be substantially the same as S370 in FIG. 5. The process from S380 to S390 may be substantially the same as the process of the corresponding step numbers in FIG. 5. After 8390, the gas purification controller 51 may proceed to S391a.

At S391a, the gas purification controller 51 may calculate an integrated value Qsum of flow of the purified gas by the following formula.

Qsum=SCCM1·Ta

SCCM1 may be the flow rate of the mass-flow controller 66. The flow rate of the mass-flow controller 66 may correspond to the flow rate of the emission gas passed through the xenon trap 57. Ta may be the value of the timer Ta at the time of calculating the integrated value Qsum of flow of the purified gas.

Next, at S400a, the gas purification controller 51 may determine whether the integrated value Qsum of flow of the purified gas has reached the threshold value Qsummax. If the integrated value Qsum of flow of the purified gas has reached the threshold value Qsummax (S400a: YES), it may be decided that the end of the lifetime of the xenon trap 57 has come. The gas purification controller 51 may thus suspend the gas purification at S410. The process of S410 may be substantially the same as that shown in FIG. 5. If the integrated value Qsum of flow of the purified gas has not reached the threshold value Qsummax (S400a: NO), the gas purification controller 51 may return to S330.

As described with reference to FIG. 5, if the pressure P3 of the high-pressure tank 59 is lower than the threshold value P3max (S350: NO), the gas purification controller 51 may set, at S360, the flow rates of the mass-flow controllers 66 and 69 both to 0. After stopping the gas flow through the mass-flow controller at 8360 in the third embodiment, the gas purification controller 51 may proceed to S361a. At S361a, the gas purification controller 51 may stop the timer Ta. Here, the value of the timer Ta at the time of stopping may be kept unchanged without resetting it. The gas purification controller 51 may then return to S330. After that, the timer Ta may be re-started at S370a described above from the value of the timer Ta at the time of stopping at S361a.

In the third embodiment, if the end of the lifetime of the xenon trap 57 has come, the gas purification may be suspended to enable replacement of the xenon trap 57. Here, as described with reference to FIG. 6, the emission gas emitted from the chamber 10 may be exhausted via the valve EX-V2 to the outside of the exhausting device 43 and the new gas may be supplied as the buffer gas via the valve B-V2 to the chamber 10. According to this, the replacement of the xenon trap 57 may have little influence on the operation of the excimer laser apparatus.

The laser gas purifying system in the third embodiment has a configuration substantially the same as that of the laser gas purifying system 50a described with reference to FIG. 4. However, the present disclosure is not limited to this. The laser gas purifying system in the third embodiment may have a configuration substantially the same as that of the laser gas purifying system 50b described with reference to FIG. 7.

### 6. Specific Configuration of Xenon Trap

### 6.1 First Exemplary Configuration

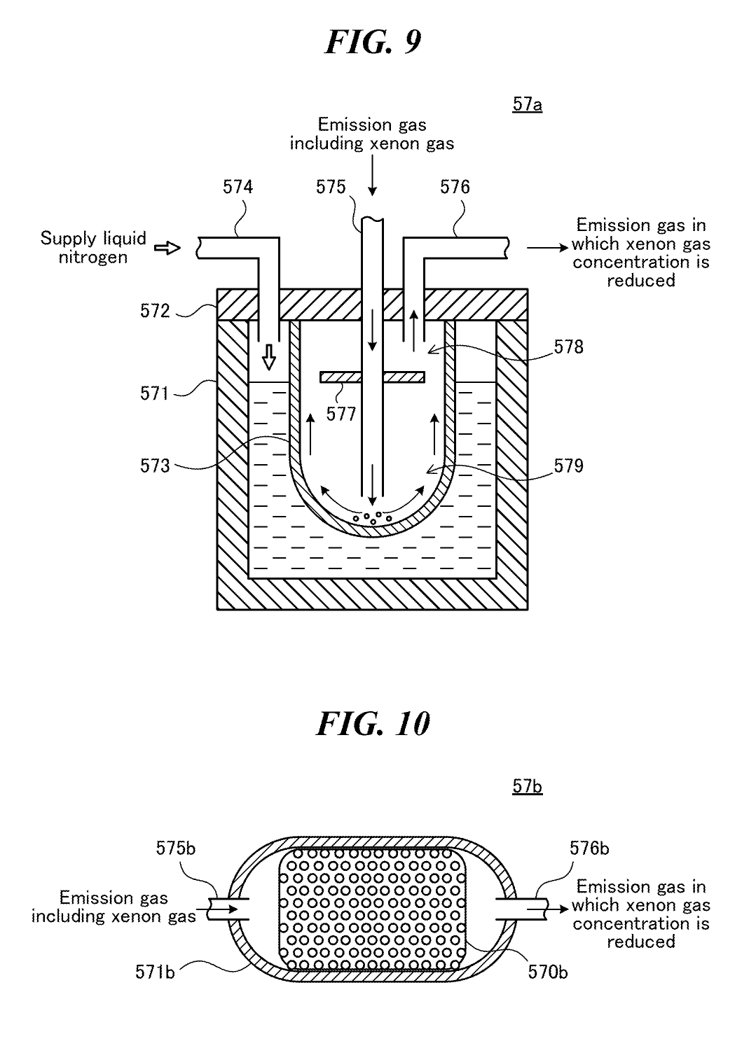

FIG. 9 is a cross-sectional view showing a first exemplary configuration of the xenon trap used in the embodiments described above. A xenon trap 57a according to the first exemplary configuration may include a liquid nitrogen container 571, a lid 572, a gas container 573, a liquid nitrogen injection pipe 574, a laser gas injection pipe 575, a laser gas discharge pipe 576, and an inner lid 577.

The lid 572 may be provided at an upper opening of the liquid nitrogen container 571. In the liquid nitrogen container 571, the gas container 573 may be fixed to the lid 572. The upper opening of the gas container 573 may be sealed by the lid 572.

The liquid nitrogen injection pipe 574, which penetrates the lid 572, may have an open end in a space in the liquid nitrogen container 571 and out of the gas container 573.

Each of the laser gas injection pipe 575 and the laser gas discharge pipe 576, which penetrates the lid 572, may have an open end in a space in the liquid nitrogen container 571 and in the gas container 573. In the gas container 573, the inner lid 577 may be fixed to the laser gas injection pipe 575. The inner lid 577 may be arranged between an upper space 578 and a lower space 579 in the space in the gas container 573. The inner lid 577 may not completely separate the upper space 578 and the lower space 579, but be configured to allow gas passage from each other. The open end of the laser gas injection pipe 575 may be in the lower space 579. The open end of the laser gas discharge pipe 576 may be in the upper space 578.

### 6.2 Operation of First Exemplary Configuration

Liquid nitrogen, having the boiling point of 77.36 K, may be supplied via the liquid nitrogen injection pipe 574 to the space in the liquid nitrogen container 571 and out of the gas container 573. The space in the gas container 573 may thus be cooled. Specifically, the lower space 579 may be cooled. Surplus gas including vaporized nitrogen gas or the like in the space in the liquid nitrogen container 571 and out of the gas container 573 may be emitted outside via unillustrated through-hole formed in the lid 572.

The emission gas passed through the oxygen trap 56 may be injected via the laser gas injection pipe 575 into the gas container 573. The emission gas injected into the gas container 573 may be emitted via the open end at the bottom of the laser gas injection pipe 575 to the lower space 579. The inner lid 577 may prevent the emission gas emitted to the lower space 579 from being immediately mixed with the gas in the upper space 578. The emission gas emitted to the lower space 579 may be cooled while being circulated in the lower space 579 for a certain time.

The boiling point of xenon may be 165.03 K and the melting point of xenon may be 161.4 K. The xenon gas included in the emission gas may be cooled in the lower space 579, being condensed or frozen to stay at the bottom end of the gas container 573. The emission gas emitted to the lower space 579 may be cooled in the lower space 579 and then escape to the upper space 578. The emission gas may then be outputted via the laser gas discharge pipe 576 to the purifier 58.

Most of the xenon gas included in the emission gas may thus be trapped.

### 6.3 Second Exemplary Configuration

FIG. 10 is a cross-sectional view showing a second exemplary configuration of the xenon trap used in the embodiments described above. A xenon trap 57b of the second exemplary configuration may include a container 571b, a laser gas injection pipe 575b, and a laser gas discharge pipe 576b. Each of the laser gas injection pipe 575b and the laser gas discharge pipe 576b, which penetrates the wall of the container 571b, may have an open end in the container 571b.

The container 571b may be sealed airtight, except that the pipes described above have gas flow paths. The container 571b may be filled with filler 570b. The filler 570b may be zeolite that may selectively adsorb xenon. The zeolite that may selectively adsorb xenon may be, for example, Ca—X type zeolite or Na—Y type zeolite. Alternatively, the filler 570b may be activated carbon.

The emission gas passed through the oxygen trap 56 may be injected via the laser gas injection pipe 575b into the container 571b. In the container 571b, xenon gas included in the emission gas may be adsorbed to the filler 570b. The emission gas may then be outputted via the laser gas discharge pipe 576b to the purifier 58.

Most of the xenon gas included in the emission gas may thus be trapped.

### 7. Specific Configuration of Xenon-Adding Unit

FIG. 11 schematically shows a second exemplary configuration of the xenon-adding unit used in the embodiments described above. A first exemplary configuration of the xenon-adding unit 61a may be that described with reference to FIG. 4. The second exemplary configuration of the xenon-adding unit 61b may include valves C-V3 and Xe-V2 provided downstream from the mass-flow controllers 66 and 69, respectively.

The valves C-V3 and Xe-V2 may be controlled by the gas purification controller 51. The setting values of the flow rates of the mass-flow controllers 66 and 69 may be fixed to SCCM1 and SCCM2, respectively. The flow rates may both be 0 when the valves C-V3 and Xe-V2 are closed.

### 8. Specific Configuration of Mixer

FIG. 12 schematically shows an exemplary configuration of the mixer 70 used in the embodiments described above. If the xenon gas concentration in the xenon-containing gas is 5% and the xenon gas concentration of the laser gas used in an ArF excimer laser apparatus is 10 ppm, for example, the flow rate of the purified gas may be approximately 5000 times as high as the flow rate of the xenon-containing gas. To uniformly mix the gas in such mixing ratio, the mixer 70 may include a pipe branching joint 71, a venturi mixer 72, and a static mixer 73.

The pipe branching joint 71 may include a first branching portion 711, a second branching portion 712, and a third branching portion 713. The first branching portion 711 may be connected to the pipe 24. The mass-flow controller 66 and the like may be provided in the pipe 24, allowing the purified gas to flow from the pipe 24 to the pipe branching joint 71. The second branching portion 712 may be connected to the pipe 20. The mass-flow controller 69 and the like may be provided in the pipe 20, allowing the xenon-containing gas to flow from the pipe 20 to the pipe branching joint 71. The third branching portion 713 may be connected to the venturi mixer 72. The purified gas from the first branching portion 711 and the xenon-containing gas from the second branching portion 712 may flow via the third branching portion 713 to the venturi mixer 72.

The venturi mixer 72 may include a venturi orifice 721 and a flow rate adjusting needle 722. The venturi orifice 721 may have a tapered portion, where the cross-section of the flow path is reduced along the flow path, and a reversed tapered portion, where the cross-section of the flow path is expanded, next to the tapered portion. The flow rate adjusting needle 722 may be provided such that the tip of the flow rate adjusting needle 722 is in the vicinity of a minimum portion where the cross-section of the flow path is the minimum in the venturi orifice 721. The flow rate adjusting needle 722 may be capable of slightly moving along the flow path.

The mixed gas of the purified gas and the xenon-containing gas flowing from the pipe branching joint 71 to the venturi mixer 72 may increase in pressure just before the minimum portion where the cross-section of the flow path is the minimum in the venturi orifice 721 and may decrease in pressure after passing through the minimum portion. The change in the pressure may generate a turbulent flow to mix the mixed gas more uniformly. Moving the flow rate adjusting needle 722 along the flow path may allow the strength of the turbulent flow to be changed. The venturi mixer 72 may be connected to the static mixer 73 to allow the mixed gas passed through the venturi mixer 72 to flow to the static mixer 73.

The static mixer 73 may include a plurality of elements 731, 732, and 733, which form twisted flow paths. The element 731 may divide the gas flowing through the pipe to first and second flow paths and twist the first and second flow paths clockwise by a half rotation. The element 732 may divide the gas passed through the element 731 to third and fourth flow paths and twist the third and fourth flow paths counterclockwise by a half rotation. The element 733 may divide the gas passed through the element 732 to fifth and sixth flow paths and twist the fifth and sixth flow paths clockwise by a half rotation. The mixed gas passed through the elements 731, 732, and 733 may thus be uniformly mixed. The static mixer 73 may be connected to the pipe 25, allowing the mixed gas passed through the static mixer 73 to flow to the pipe 25.

### 9. Configuration of Controller

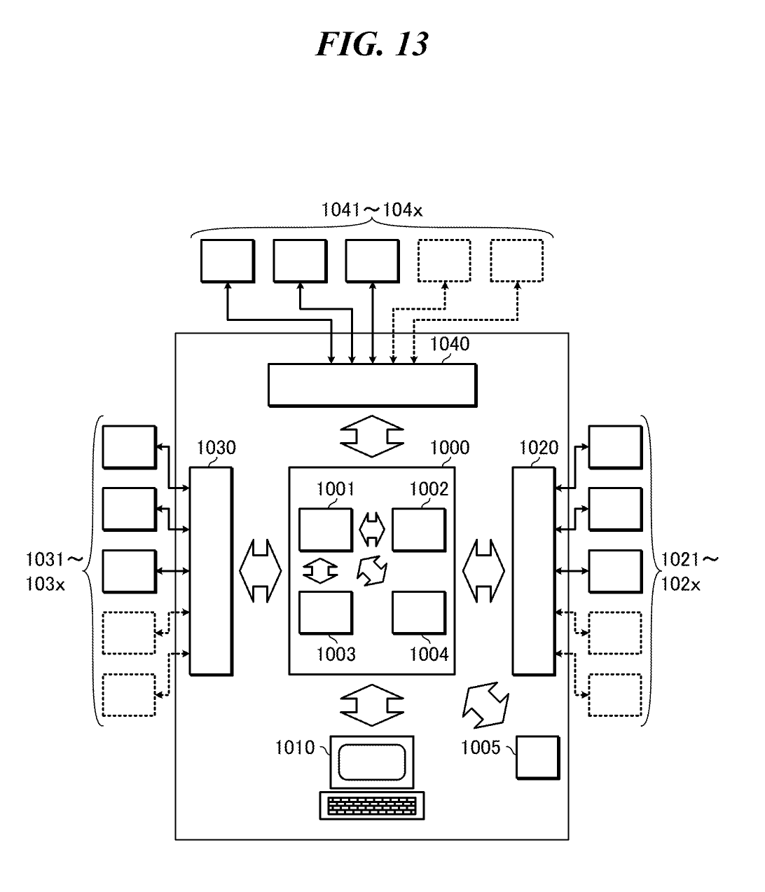

FIG. 13 is a block diagram showing a general configuration of the controller.

Controllers of the above-described embodiments, such as the gas purification controller 51, may be configured by general-purpose control devices, such as computers or programmable controllers. For example, the controllers may be configured as follows.

Configuration

The controllers may each be configured by a processor 1000, and a storage memory 1005, a user interface 1010, a parallel input/output (I/O) controller 1020, a serial I/O controller 1030, and an analog-to-digital (A/D) and digital-to-analog (D/A) converter 1040 which are connected to the processor 1000. The processor 1000 may be configured by a central processing unit (CPU) 1001, and a memory 1002, a timer 1003, and a graphics processing unit (GPU) 1004 which are connected to the CPU 1001.

Operation

The processor 1000 may read a program stored in the storage memory 1005, execute the read program, read data from the storage memory 1005 in accordance with the program, or store data in the storage memory 1005.

The parallel I/O controller 1020 may be connected to devices 1021 to 102x with which it may communicate through parallel I/O ports. The parallel I/O controller 1020 may control digital-signal communication through the parallel I/O ports while the processor 1000 executes the program.

The serial I/O controller 1030 may be connected to devices 1031 to 103x with which it may communicate through serial I/O ports. The serial I/O controller 1030 may control digital-signal communication through the serial I/O ports while the processor 1000 executes the program.

The A/D and D/A converter 1040 may be connected to devices 1041 to 104x with which it may communicate through analog ports. The A/D and D/A converter 1040 may control analog-signal communication through the analog ports while the processor 1000 executes the program.

The user interface 1010 may be configured to display the progress of the program being executed by the processor 1000 in accordance with instructions from an operator, or to allow the processor 1000 to stop the execution of the program or perform an interrupt in accordance with instructions from the operator.

The CPU 1001 of the processor 1000 may perform arithmetic processing of the program. The memory 1002 may temporarily store the program being executed by the CPU 1001 or temporarily store data in the arithmetic processing. The timer 1003 may measure time or elapsed time and output it to the CPU 1001 in accordance with the program being executed. When image data is inputted to the processor 1000, the GPU 1004 may process the image data in accordance with the program being executed and output the results to the CPU 1001.

The devices 1021 to 102x, which are connected through the parallel I/O ports to the parallel I/O controller 1020, may be the excimer laser apparatus 30, the exposure apparatus 100, other controllers, or the like.

The devices 1031 to 103x, which are connected through the serial I/O ports to the serial I/O controller 1030, may be the mass-flow controller 66 or 69, or the like.

The devices 1041 to 104x, which are connected through the analog ports to the A/D and D/A converter 1040, may be various sensors such as the pressure sensor 54 or 60, or the like.

The controllers thus configured may be capable of realizing the operations described in the embodiments.

The above descriptions are intended to be only illustrative rather than being limiting. Accordingly, it will be clear to those skilled in the art that various changes may be made to the embodiments of the present disclosure without departing from the scope of the appended claims.

The terms used in this specification and the appended claims are to be interpreted as not being limiting. For example, the term “include” or “included” should be interpreted as not being limited to items described as being included. Further, the term “have” should be interpreted as not being limited to items described as being had. Furthermore, the modifier “a” or “an” as used in this specification and the appended claims should be interpreted as meaning “at least one” or “one or more”.

1. A laser gas purifying system configured to purify emission gas emitted from an ArF excimer laser apparatus using laser gas including xenon gas and to supply purified gas to the ArF excimer laser apparatus, comprising:
a xenon trap configured to reduce xenon gas concentration in the emission gas; and
a xenon-adding unit configured to add xenon gas to the emission gas passed through the xenon trap.

2. The laser gas purifying system according to claim 1, further comprising a first impurity trap configured to purify the emission gas emitted from the ArF excimer laser apparatus, wherein
the xenon trap reduces the xenon gas concentration in the emission gas passed through the first impurity trap.

3. The laser gas purifying system according to claim 1, further comprising a second impurity trap configured to purify the emission gas passed through the xenon trap.

4. The laser gas purifying system according to claim 2, further comprising a second impurity trap configured to purify the emission gas passed through the xenon trap.

5. The laser gas purifying system according to claim 1, wherein the xenon-adding unit includes:
a gas cylinder configured to store laser gas that contains xenon gas,
a mixer configured to mix the laser gas supplied from the gas cylinder and the emission gas passed through the xenon trap,
a first control valve provided between the mixer and the gas cylinder,
a second control valve provided between the mixer and the xenon trap, and
a controller configured to control the first control valve and the second control valve.

6. The laser gas purifying system according to claim 1, wherein the xenon trap is a low-temperature trap set to a temperature equal to or lower than the melting point of xenon gas.

7. The laser gas purifying system according to claim 1, wherein the xenon trap includes at least one of zeolite and activated carbon so as to trap xenon gas.

8. The laser gas purifying system according to claim 1, further comprising:
a flow meter configured to measure a flow rate of the emission gas passed through the xenon trap; and
a controller configured to determine an end of a lifetime of the xenon trap based on an integrated value of the flow rate measured by the flow meter.

9. The laser gas purifying system according to claim 5, further comprising a flow meter configured to measure a flow rate of the first control valve, wherein
the controller determines an end of a lifetime of the xenon trap based on an integrated value of the flow rate measured by the flow meter.
